(19) United States
(12) Patent Application Publication
(10) Pub. No.: US 2016/0253273 A1
(43) Pub. Date: Sep. 1, 2016

(54) HUB, OPERATION SYSTEM, AND CONTROL METHOD THEREOF

(71) Applicant: VIA TECHNOLOGIES, INC., New Taipei City (TW)

(72) Inventors: Po-Chou LIN, New Taipei City (TW); Hao-Hsuan CHIU, New Taipei City (TW)

(21) Appl. No.: 14/700,507

(22) Filed: Apr. 30, 2015

(30) Foreign Application Priority Data
Feb. 26, 2015 (TW) 104106171

(51) Int. Cl. G06F 13/10; G06F 1/32; G06F 13/42

(52) U.S. Cl. CPC G06F 13/102; G06F 13/4282; G06F 1/3296

(57) ABSTRACT

A hub including an up-stream port, at least one down-stream port, a state-determining unit, and a control unit is provided. The up-stream port is configured to be coupled to a host device. The down-stream port is configured to be coupled to at least one peripheral device. The state-determining unit is coupled to the down-stream port and generates a determination result according to a level of a pin of the down-stream port. The control unit is coupled between the up-stream port and the state-determining unit. When the host device sends a sleep request, the control unit determines whether the peripheral device is operating in a specific mode according to the determination result. When the peripheral device is operating in the specific mode, the control unit provides an unready response to the host device.

### CROSS REFERENCE TO RELATED APPLICATIONS

This Application claims priority of Taiwan Patent Application No. 104106171, filed on Feb. 26, 2015, the entirety of which is incorporated by reference herein.

### BACKGROUND OF THE INVENTION

1. Field of the Invention

The invention relates to a hub, and more particularly to a USB hub.

2. Description of the Related Art

With the continued development of technology, the types of digital devices available such as flash disks, outer-type DVD players, outer-type hard disks, digital cameras, smartphones, and so on, have increased. These digital devices generally include a connector to connect to a host device. When the host device is connected to any digital devices, the host device is capable of accessing the digital devices. However, the host device does not include enough connectors to connect to many digital devices at once.

### BRIEF SUMMARY OF THE INVENTION

In accordance with an embodiment, a hub includes an up-stream port, at least one down-stream port, a state-determining unit, and a control unit. The up-stream port is configured to be coupled to a host device. The down-stream port is configured to be coupled to at least one peripheral device. The state-determining unit is coupled to the down-stream port and generates a determination result according to a level of a pin of the down-stream port. The control unit is coupled between the up-stream port and the state-determining unit. When the host device sends a sleep request, the control unit determines whether the peripheral device is operating in a specific mode according to the determination result. When the peripheral device is operating in the specific mode, the control unit provides an unready response to the host device.

In accordance with another embodiment, an operation system includes a host device and a hub. The host device is configured to send a sleep request. The hub is coupled between the host device and at least one peripheral device. After receiving the sleep request, the hub determines whether the peripheral device is operating in a specific mode. When the peripheral device is operating in the specific mode, the hub provides an unready response to the host device.

In accordance with a further embodiment, a control method for a hub coupled between a host device and at least one peripheral device includes receiving a sleep request; determining whether the peripheral device is operating in a specific mode; and generating an unready response when the peripheral device is operating in the specific mode.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an operation system of the invention;

FIG. 2 is a schematic diagram of an exemplary embodiment of a hub of the invention; and

FIG. 3 is a flowchart of an exemplary embodiment of a control method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

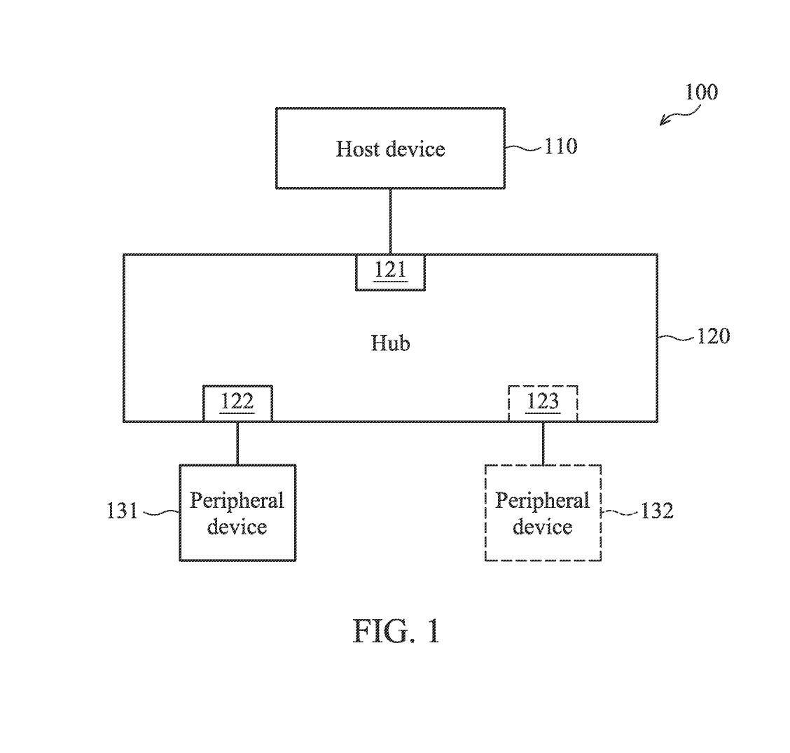

FIG. 1 is a schematic diagram of an exemplary embodiment of an operation system of the invention. The operation system 100 includes a host device 110 and a hub 120. The invention does not limit the kind of hub 120. In this embodiment, the hub 120 is a USB hub. As shown in FIG. 1, the hub 120 includes an up-stream port 121 and a down-stream port 122.

The up-stream port 121 is configured to be coupled to the host device 110. The down-stream port 122 is coupled to a peripheral device 131. In one embodiment, the hub 120 uses a USB 2.0 communication protocol to communicate with the peripheral device 131. Additionally, the invention does not limit the number of down-steam ports. In other embodiments, the hub 120 may include a plurality of down-stream ports, such as 122˜123. The down-stream port is configured to be coupled to another peripheral device 132.

When the host device 110 desires to enter a sleep mode, the host device 110 sends a sleep request to the hub 120. In one embodiment, the sleep mode is the L1 mode (sleep) of the USB 2.0 communication protocol. After receiving the sleep request, when the hub 120 is coupled to a single peripheral device (e.g. 131), the hub 120 determines whether the peripheral device 131 is operating in a specific mode. In one embodiment, the specific mode is at least one of the L2 mode (suspend) or the L0 mode (enabled) of the USB 2.0 communication protocol.

When the peripheral device 131 is operating in the specific mode, the hub 120 provides an unready response to the host device 110. Therefore, the host device 110 does not enter the sleep mode provisionally. However, when the peripheral device 131 is not operating in the specific mode, the hub 120 provides a ready response to the host device 110. The host device 110 enters the sleep mode according to the ready response. In one embodiment, when the peripheral device 131 is operating in the L1 mode of the USB 2.0 communication protocol, the hub 120 provides a ready response to the host device 110 such that the host device 110 enters the L1 mode. Therefore, when the host device 110 enters the L1 mode, the peripheral device 131 is also operating in the L1 mode of the USB 2.0 communication protocol.

In another embodiment, if the hub 120 is coupled to the peripheral devices 131 and 132, when the host device 110 sends the sleep request, the hub 120 determines whether each of the peripheral devices 131 and 132 is not operating in a specific mode. When one of the peripheral devices 131 and 132 is operating in the specific mode, the hub 120 provides an unready response to the host device 110. Therefore, the host device 110 does not enter the L1 mode defined by the USB 2.0 communication protocol. When each of the peripheral devices 131 and 132 is not operating in the specific mode (e.g. at least one of the L2 mode and the L0 mode defined by the USB 2.0 communication protocol), the hub 120 provides a ready response to the host device 110. Therefore, the host device 110 enters the L1 mode of the USB 2.0 communication protocol.

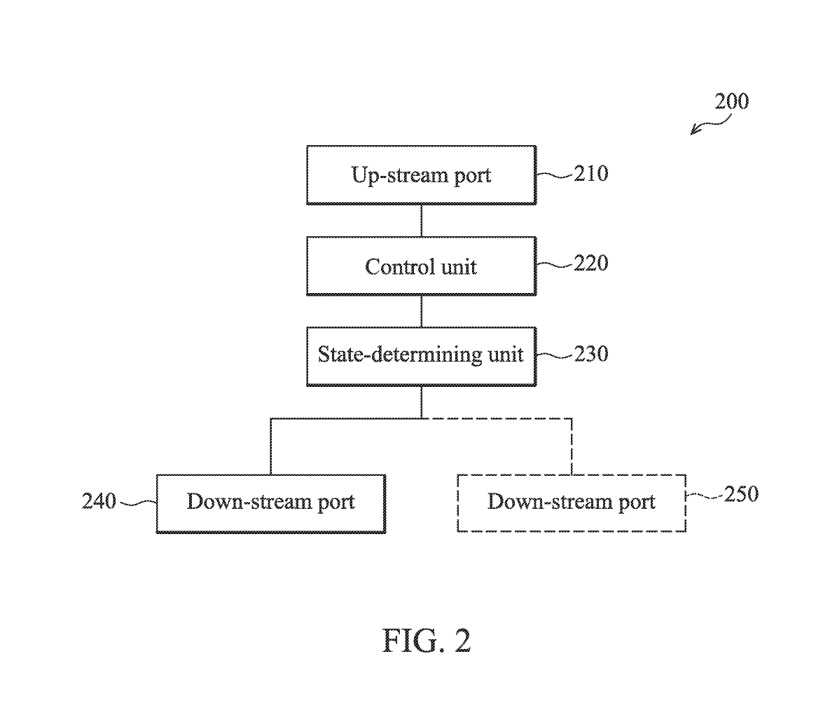

FIG. 2 is a schematic diagram of an exemplary embodiment of a hub of the invention. The hub 200 includes an up-stream port 210, a control unit 220, a state-determining unit 230, and a down-stream port 240. The up-stream port 210 is configured to couple a host device, such as 110. The down-stream port 240 is configured to be coupled to a peripheral device, 131. In some embodiments, the hub 200 includes a plurality of down-stream ports, such as 240 and 250. Each of the down-stream ports 240 and 250 is configured to be coupled to a peripheral device. In one embodiment, the down-stream port 240 is a USB 2.0 port.

The state-determining unit 230 is coupled to the down-stream port 240 and generates at least one determination result according to the level of the pin of the down-stream port 240. In this embodiment, the state-determining unit 230 can determine the operation mode of the peripheral device according to the level of the pin of the down-stream port 240 and provides the determination result to the control unit 220.

The control unit 220 is coupled to the up-stream port 210 and the state-determining unit 230. When the control unit 220 receives a sleep request provided from the host device, the control unit 220 determines whether the peripheral device coupled to the down-stream port is operating in a specific mode according to the determination result generated by the state-determining unit 230.

When the peripheral device coupled to the down-steam 240 is operating in the specific mode, the control unit 220 provides an unready response to the host device. When the host device receives the unready response, the host device does not enter the L1 mode temporarily. However, when the peripheral device coupled to the down-steam 240 is not operating in the specific mode, the control unit 220 provides a ready response to the host device. When the host device receives the ready response, the host device enters the L1 mode. In one embodiment, the specific mode is at least one of the L2 and L1 modes defined by the USB 2.0 communication protocol. In some embodiments, when the peripheral device coupled to the down-steam 240 is operating in the L1 mode defined by the USB 2.0 communication protocol, the control unit 220 provides the ready response to the host device.

When the hub 200 includes a plurality of down-stream ports, the state-determining unit 230 determines the operation modes of all of the peripheral devices coupled to the down-stream ports and provides the determination results to the control unit 220. In this embodiment, when each of the peripheral devices is not operating in the specific mode, the control unit 220 sends a ready response to the host device. When one of the peripheral devices is operating in the specific mode, the control unit 220 sends an unready response to the host device.

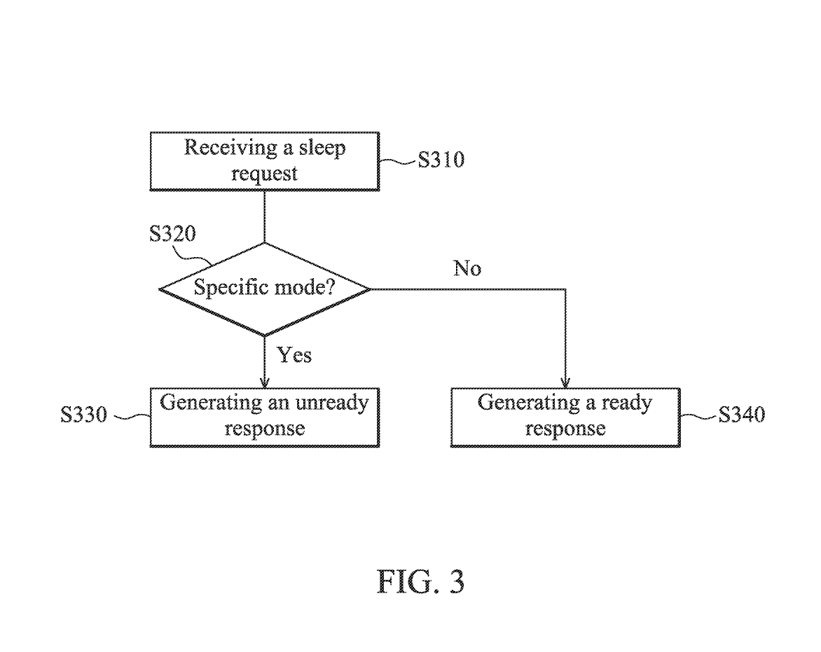

FIG. 3 is a flowchart of an exemplary embodiment of a control method of the invention. The control method is applied to a hub coupled between a host device and at least one peripheral device. In one embodiment, the hub is a USB hub. In another embodiment, the hub includes at least one down-stream port configured to be coupled to a peripheral.

First, a sleep request is received (step S310). In this embodiment, the sleep request is provided by the host device. When the host device desires to enter a sleep mode, such as the L1 mode of the USB 2.0 communication protocol, the host device sends a sleep request to the hub.

Then, it is determined whether the peripheral device is operating in a specific mode (step S320). The invention does not limit how the operation mode of the peripheral device is determined. In one embodiment, the level of the pin of the down-stream port is determined to obtain the operation mode of the peripheral device.

When the peripheral device is operating in the specific mode, an unready response is generated (step S330). In this embodiment, the hub generates the unready response to forbid the host device from entering the L1 mode of the USB 2.0 communication protocol. In one embodiment, the specific mode is at least one of the L2 and the L0 modes of the USB 2.0 communication protocol.

However, when the peripheral device is not operating in the specific mode, a ready response is generated (step S340). The host device enters the L1 mode of the USB 2.0 communication protocol according to the ready response. In one embodiment, when the peripheral device is operating in the L1 mode of USB 2.0 communication protocol, the hub generates the ready response to the host device.

The invention does not limit the number of peripheral devices. When the hub is coupled to a single peripheral device, and the peripheral device is operating in the specific mode, the hub generates an unready response until the peripheral device is not operating in the specific mode. However, if the hub is coupled to a plurality of peripheral devices, when each peripheral device is not operating in the specific mode, the hub generates a ready response. When one of the peripheral devices is operating in the specific mode, the hub generates the unready response to the host device.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hub, comprising:
a up-stream port configured to be coupled to a host device;
at least one down-stream port configured to be coupled to at least one peripheral device;
a state-determining unit coupled to the down-stream port and generating a determination result according to a level of a pin of the down-stream port; and
a control unit coupled between the up-stream port and the state-determining unit;
wherein when the host device sends a sleep request, the control unit determines whether the peripheral device is operating in a specific mode according to the determination result, and when the peripheral device is operating in the specific mode, the control unit provides an unready response to the host device.

2. The hub as claimed in claim 1, wherein the specific mode comprises an L2 mode and an L0 mode of a USB 2.0 communication protocol.

3. The hub as claimed in claim 1, wherein when the peripheral device is not operating in the specific mode, the control unit provides a ready response to the host device.

4. The hub as claimed in claim 3, wherein when the peripheral device is operating in an L1 mode of a USB 2.0 communication protocol, the control device provides the ready response to the host device.

5. The hub as claimed in claim 1, wherein when the hub comprises a plurality of determining unit generates a plurality of determination results according to levels of pins of the down-stream ports, when the host device sends the sleep request, the control unit determines whether the peripheral devices are operating in the specific mode according to the determination results, and when one of the peripheral devices is operating in the specific mode, the control unit provides the unready response to the host device.

6. An operation system:
a host device configured to send a sleep request; and
a hub coupled between the host device and at least one peripheral device;
wherein after receiving the sleep request, the hub determines whether the peripheral device is operating in a specific mode, and when the peripheral device is operating in the specific mode, the hub provides an unready response to the host device.

7. The operation system as claimed in claim 6, wherein when the hub sends the unready response, the host device does not enter an L1 mode of a USB 2.0 communication protocol.

8. The operation system as claimed in claim 6, wherein when the peripheral is not operating in the specific mode, the hub provides a ready response to the host device, and the host enters an L1 mode of a USB 2.0 communication protocol according to the ready response.

9. The operation system as claimed in claim 6, wherein when the host device enters an L1 mode of a USB 2.0 communication protocol, the peripheral device is already operating in the L1 mode of the USB 2.0 communication protocol.

10. The operation system as claimed in claim 6, wherein the hub is coupled to a plurality of peripheral devices, when the host device sends the sleep request, the hub determines whether each of the peripheral devices is operating in the specific mode, and when one of the peripheral devices is operating in the specific mode, the hub provides the unready response to the host device.

11. A control method for a hub coupled between a host device and at least one peripheral device, comprising:
receiving a sleep request;
determining whether the peripheral device is operating in a specific mode; and
generating an unready response when the peripheral device is operating in the specific mode.

12. The control method as claimed in claim 11, wherein the unready response is utilized to forbid the host from entering an L1 mode of a USB 2.0 communication protocol.

13. The control method as claimed in claim 11, further comprising:
generating a ready response to the host device when the peripheral device is not operating in the specific mode.

14. The control method as claimed in claim 13, wherein when the peripheral device is operating in an L1 mode of a USB 2.0 communication protocol, the ready response is provided to the host device, and the host device enters the L1 mode of the USB 2.0 communication protocol.

15. The control method as claimed in claim 11, wherein the specific mode comprises an L2 mode and an L0 mode of a USB 2.0 communication protocol.
